(19) United States
(12) Patent Application Publication
(10) Pub. No.: US 2015/0231797 A1
(43) Pub. Date: Aug. 20, 2015

(54) APPARATUS FOR CASTING CONCRETE PRODUCTS

(71) Applicant: Elematic Oy Ab, Akaa (FI)

(72) Inventor: Jani EILOLA, Lempaala (FI)

(73) Assignee: ELEMATIC OY AB, Akaa (FI)

(21) Appl. No.: 14/546,437

(22) Filed: Nov. 18, 2014

(30) Foreign Application Priority Data
Nov. 19, 2013 (FI) 20136156

(51) Int. Cl. B28B 1/087

(52) U.S. Cl. CPC B28B 1/087

(57) ABSTRACT

An apparatus for casting a concrete product in a mold, said apparatus comprising a concrete mix container to be moved above the casting mold, a nozzle attached to the mix container bottom for feeding concrete mix from the concrete container in a casting mold, and a vertically movable closing element extending through the concrete mix container in the area of the nozzle, wherein the width of the nozzle in first direction is substantially greater than the width of the nozzle in second direction, which second direction is perpendicular in relation to the said first direction, and said concrete mix container is fixed rotatably around its vertical central axis.

This application claims benefit of Finnish Patent Application No. 20136156, filed 19 Nov. 2013.

### BACKGROUND

1. Field

The present disclosure relates to casting concrete products by mold casting. More specifically, the disclosure relates to an apparatus for feeding concrete mix to a mold formed on the casting bed.

2. Description of Related Art

When manufacturing concrete products by mold casting, the manufacturing process is started by first forming on the casting bed a mold that defines the measures of the product to be cast. Generally this is nowadays carried out by forming the mold on a metallic tiltable casting table of mold sidewall elements that are attached by means of magnets. When the mold defining the external measures of the mold is finished, inside the mold there are, when necessary, respectively formed areas bordered by sidewall elements, for example for windows, doors or other corresponding allocations defining the casting area of the cast product. Moreover, when necessary, various devices are placed on the casting table inside the mold for forming the required allocations, such as cardboard, provided with surface retarder, that is set on the casting table when casting graphic concrete. At the final stage of preparing the mold, it is provided with the necessary reinforcements, after which concrete mix is cast in the mold.

When casting concrete mix in a mold, it is generally fed from a concrete mix casting equipment proceeding above the mold. With a tilting mold, this casting of concrete mix in a mold is carried out from casting equipment located above the casting table, or brought above the casting table. When casting in a circulating mold line, a moving casting mold is generally brought to a vibrating station, which vibrating station is provided with casting equipment, and where the casting of concrete mix in a mold is carried out.

Possibly already during the casting of concrete mix, and not later than after the concrete mix has been cast in the mold, the mold filled with concrete mix is vibrated for compacting the concrete mix, and for ensuring that the mold is properly filled. With tilting molds, said vibration is realized for example by means of vibrators arranged in the casting table legs, and with a circulating mold line, in a vibrating station, where the concrete mix is cast in a mold, said vibrating station being provided with vibrators for vibrating the casting mold.

The concrete mix used in mold casting can be, for example, regular or self-compacting concrete. Various different color concrete mixtures can also be used as part of the element to be cast, or when necessary, the whole element can be cast in color concrete in order to obtain a desired color for the concrete to be cast.

With a tilting mold, after the cast concrete product has cured, the product is removed from the casting mold by removing part of the mold, by tilting the casting table and by lifting the product away from the casting table by means of lifting lugs or ears provided in the product. In a circulating mold line, the mold is transferred to a separate tilting station for removing the cast product from the mold.

The patent publication EP 0 512 776 specifies an apparatus used for casting concrete in a mold, where concrete mix is fed in a casting mold from a casting apparatus moving above the mold, said apparatus comprising a concrete mix storage tank and a nozzle connected thereto. The casting arrangement also comprises a vibrator for fluidizing the concrete mix to be cast prior to casting the concrete mix in the mold. In the arrangement described in said publication, the nozzle element is connected to the bottom of the concrete mix storage tank, and the nozzle unit is opened or closed, for respectively starting or ending the feeding of concrete mix, by a shutter element that is moved vertically by intermediation of a rod extending through the interiors of the nozzle element and the concrete mix storage tank. The publication also describes a bellows-type arrangement for adjusting the mass flow proceeding through the nozzle, in which a bellows system provided inside the nozzle can, when necessary, be used for reducing the inner diameter of the nozzle by filling the bellows with for example pressurized air or oil.

The patent publication EP 2 397 297 specifies an apparatus wherein the casting arrangement is provided with an adjustable casting opening, i.e. an aperture for adjusting the outer dimensions of the mass flow fed in the mold from the casting apparatus, said casting opening forming part of the adjustable casting duct. Thus the outer dimensions of the concrete mix mass flow to be fed in the mold from the casting apparatus can be can adjusted to be suitable with respect to the various different narrow spots and borders existing in the mold. The adjusting of the casting opening can be realized by adjusting the cross-section of the whole casting duct in the casting apparatus, so that also the cross-section of the casting opening may be adjusted respectively.

The present invention provides a solution for efficiently filling the narrow gaps left in the casting mold while maintaining the capacity and casting speed the same or even increasing it. The casting apparatus is provided with a casting opening which can advantageously be rotated in relation to the casting mold when the various different narrow spots and borders can be fed with the concrete mix. By turning the casting arrangement, all the places of the casting mold can be fed by the same casting rate because the area of the casting opening is constant.

In this connection, the term “casting opening” refers to the aperture through which the concrete mix exits from the casting apparatus when feeding concrete mix in a casting mold.

### SUMMARY

According to embodiments of the present invention, the apparatus for casting the concrete product in the mold comprises a concrete mix container, which is movable above the casting mold, a nozzle attached to bottom of the concrete mix container for feeding concrete mix from the concrete mix container to the casting mold and a vertically movable closing element extending through the concrete mix container in the area of the nozzle, wherein the width of the nozzle in first direction is substantially greater than the width of the nozzle in second direction, which second direction is perpendicular in relation to the said first direction. The said two width directions of the nozzle are both horizontal directions extending along a horizontal plane.

The concrete mix container is also fixed rotatably around its vertical central axis. This allows the orientation of the nozzle to be change in relation to the casting mold when the narrow gaps left in the casting mold can be efficiently filled. Also, wider gaps can be efficiently filled by turning the concrete mix container around its vertical central axis. The orientation of the nozzle is changed, but the casting rate is the same because the area of the casting opening is constant.

The turning radius of the concrete mix container is advantageously at least 90°. On the other hand, the nozzle can be fixed eccentrically to the concrete mix container, which allows casting concrete mix to the mold near the edges of the mold in the situations where pillars of the manufacturing facility restrict the movement of the casting apparatus, for example.

The vertically movable closing element is used to adjust the concrete mix mass flow from the casting apparatus to the mold, and to start and end the casting of the concrete mix to the mold. Advantageously the vertically movable closing element also comprises one or more vibrators for fluidization of the concrete mix in the nozzle area and also in the concrete mix container in order to improve the flow of the concrete mix from the casting apparatus to the mold.

The vibrator or vibrators may be located inside the vertically extending closing element, or at the upper end of the closing element. The vibrators may be mechanical vibrators conveying the vibration effect to and along the vertically extending closing element through mechanical connection, or the vibrators may be hydraulic or pneumatic vibrators where hydraulic or pneumatic pressure waves or impulses are conveyed between two plates, for example, for creating the vibration effect.

The nozzle of the casting apparatus of the invention has advantageously a rectangular form, but the form of the nozzle may also be an ellipse or rectangular with rounded corners, for example.

Preferably, the nozzle's width in the first direction is 100-2000 mm and in the second direction 30-700 mm.

More precisely, the features of an embodiment of an apparatus of the invention relate to an apparatus for casting a concrete product in a mold, said apparatus comprising a concrete mix container to be moved above the casting mold, a nozzle attached to the mix container bottom for feeding concrete mix from the concrete container in a casting mold, and a vertically movable closing element extending through the concrete mix container in the area of the nozzle, characterized in that the width of the nozzle in first direction is substantially greater than the width of the nozzle in second direction, which second direction is perpendicular in relation to the said first direction, and that said concrete mix container is fixed rotatably around its vertical central axis.

### BRIEF DESCRIPTION OF DRAWINGS

The embodiments of the invention will be described in more detail by means of example in the following, with reference to the enclosed drawings, wherein

FIG. 1 shows schematically an embodiment of an apparatus of the invention for casting concrete products in front view,

FIGS. 2A, 2B, 2C and 2D show schematically embodiments for an apparatus of the invention for casting concrete products as a view from below, and

FIG. 3 shows schematically an embodiment of an apparatus of the invention for casting concrete products as a cross-section.

### DETAILED DESCRIPTION OF SPECIFIC EMBODIMENTS

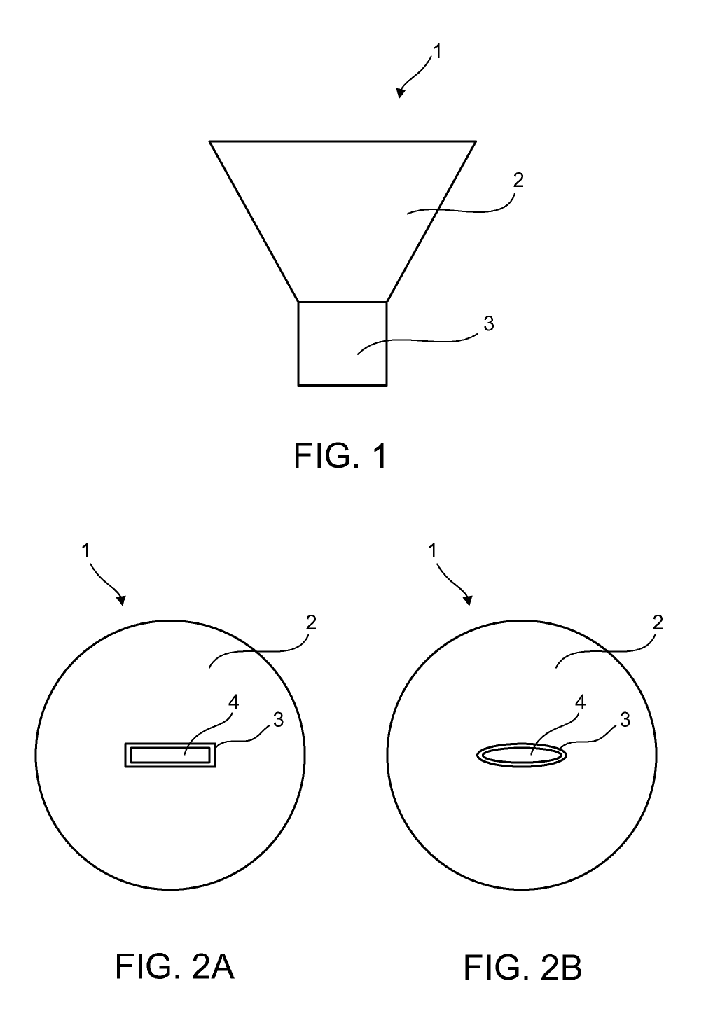

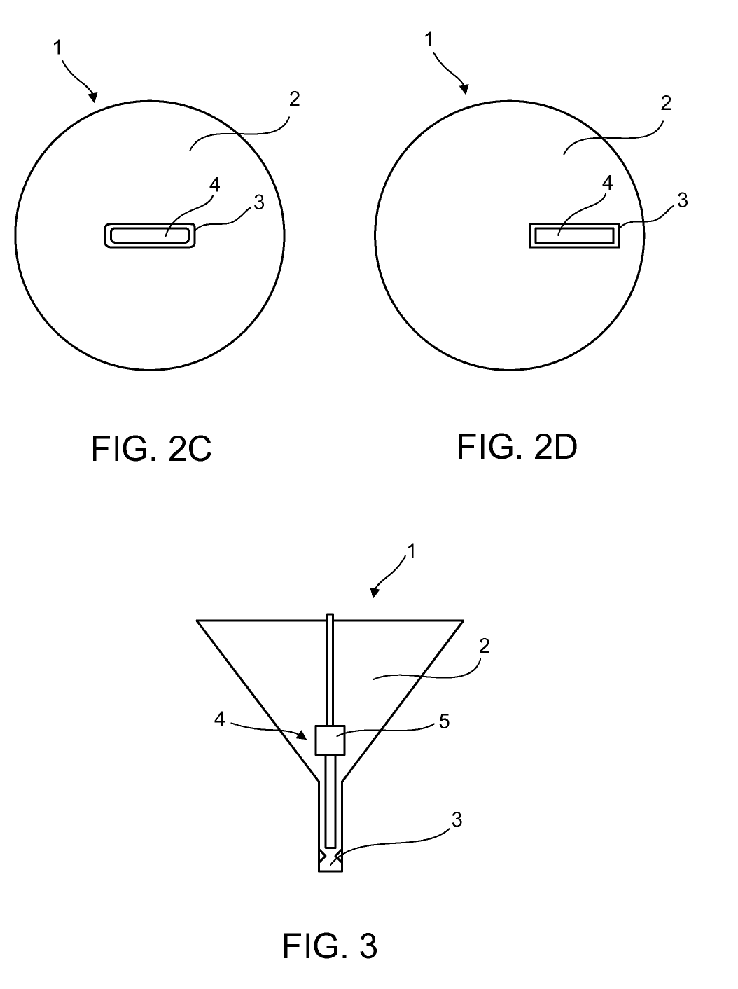

FIG. 1 illustrates a casting apparatus of an embodiment of the invention in front view, FIGS. 2A, 2B, and 2C illustrate the same casting apparatus with different nozzle forms as viewed from below, and FIG. 2D illustrates an embodiment of a casting apparatus with eccentric nozzle as viewed from below.

The casting apparatus 1 illustrated in FIGS. 1 and 2A-2D comprises a concrete mix container 2 and to the bottom of the concrete mix container 2, there is connected a nozzle 3 constituting the casting duct of the casting apparatus 1 for feeding concrete mix from the concrete container 1 in a casting mold.

FIGS. 2A-2D show that the width of the nozzle 3 in a first direction is substantially greater than the width of the nozzle 3 in a second direction, which second direction is perpendicular in relation to the said first direction.

While using the casting apparatus 1, the prepared concrete mix is first brought in the concrete mix container 2 of the apparatus 1, from where it is conducted, when casting concrete mix, to a nozzle 3, and further through a casting opening, to the mold of the concrete product to be cast. During the casting process, the casting apparatus 1 is moved above the casting mold for guiding the concrete mix to the correct spots in the casting mold, and in order to ensure that the casting mold is filled correctly by turning concrete mix container 2 around its vertical central axis which provides a solution for efficiently filling the narrow gaps left in the casting mold. By changing the orientation of the nozzle 3 the casting rate is the same because the area of the casting opening is constant.

The nozzle 3 has advantageously a rectangular form as shown in FIGS. 2A and 2D. The form of the nozzle 3 can be also, for example, be an ellipse or rectangular with rounded corners, as shown in FIGS. 2B and 2C. The concrete mix container 2 is connected rotatably to a supporting structure, such as a trolley of a bridge crane for example, so that the nozzle 3 can be turned to proper alignment with respect to the mold or a portion of the mold.

FIG. 2D shows an embodiment of the apparatus 1 in which the nozzle 3 is fixed eccentrically at the bottom of the concrete mix container 2. This embodiment allows movement of the nozzle 3 with respect to the vertical center axis of the concrete mix container 2 by rotating the concrete mix container 2.

In the FIGS. 2A-2D, the apparatus 1 comprises a vertically adjustable closing member 4 which extends in the area inside the nozzle 3. The closing member 4 has the same form than the nozzle 3 but the closing member 4 is smaller than the nozzle 3. The concrete mix is fed to the casting mold from the gap that is left in between the nozzle 3 and the closing member 4, and the concrete mix mass flow is adjusted by vertical movement of the closing member 4.

The closing member 4 advantageously comprises one or more vibrators for facilitating flow of the concrete mix through the nozzle 3. In the embodiments shown in FIGS. 2A-2D, the vibrator or vibrators are located inside the closing member 4, advantageously at the lower end of the closing member 4. The elongated shape of the cross-section of the closing member 4 allows for plurality of vibrators to be located side by side in the closing member 4. The vibrators used may be mechanical, hydraulic or pneumatic vibrators.

In the embodiment of FIG. 3, the closing member 4 extending inside the area of the nozzle 3 comprises a vibrator mechanism 5, which vibrator mechanism can be mechanical, hydraulic or pneumatic, located on top of the closing member 4. The vibrator mechanism 5 of the closing member 4 is located inside the concrete mix container 2 and the vibration effect is conveyed through the closing member with mechanical connection between the vibrator mechanism 5 and the closing member 4, or with hydraulic or pneumatic waves or impulses, depending on what type of vibrator or vibrators is used.

With regard to the foregoing examples, it is obvious that these are subject to a multitude of modifications and variations within the scope of the invention, as is evident for a person skilled in the art. Therefore, the foregoing embodiments of the invention are by no means limitative regarding the invention, but the scope of protection for the invention is solely defined in accordance with the appended claims.

1. An apparatus for casting a concrete product in a mold, comprising:
a concrete mix container to be moved above the casting mold,
a nozzle attached to the mix container bottom for feeding concrete mix from the concrete container in a casting mold, and
a vertically movable closing element extending through the concrete mix container in the area of the nozzle,
wherein the nozzle has a width in a first direction that is substantially greater than a width of the nozzle in a second direction, wherein the second direction is perpendicular in relation to the first direction, and
that wherein the concrete mix container is fixed rotatably around a vertical central axis.

2. The apparatus according to claim 1, wherein the vertically movable closing element comprises one or more vibrators.

3. The apparatus according to claim 1, wherein the nozzle has a rectangular form.

4. The apparatus according to claim 1, wherein the width of the nozzle in the first direction is 100-2000 mm and the width of the nozzle in the second direction is 30-700 mm.

5. The apparatus according to claim 1, wherein the concrete mix container has a turning radius that is at least 90°.

6. The apparatus according claim 1, wherein the nozzle is fixed eccentrically to the concrete mix container.
